(19) United States
(12) Patent Application Publication
(10) Pub. No.: US 2007/0284369 A1
(43) Pub. Date: Dec. 13, 2007

(54) PACKAGING FOR USE IN HEATING FOOD IN A MICROWAVE OVEN AND METHOD OF USE

(75) Inventor: R. C. Murray, Lakewood, FL (US)

Correspondence Address: GIFFORD, KRASS, SPRINKLE,ANDERSON & CITKOWSKI, P.C, PO BOX 7021, TROY, MI, 48007-7021, US

(73) Assignee: PPi Technologies, Inc., Sarasota, FL (US)

(21) Appl. No.: 11/738,821

(22) Filed: Apr. 23, 2007

Related U.S. Application Data
(62) Division of application No. 10/228,430, filed on Aug. 27, 2002, now abandoned.
(60) Provisional application No. 60/315,207, filed on Aug. 27, 2001.

(51) Int. Cl. A47J 36/00

(52) U.S. Cl. 219/735

(57) ABSTRACT

A flexible package for storing and heating a precooked food product in a microwave oven includes an upper portion and a lower portion detachably connected to the upper portion. The lower portion includes a side defining a cavity adapted to hold the food product during heating and to serve the food product after the upper portion is removed. A vent is disposed in an aperture in the upper portion that operatively opens to release steam, and the vent is a valve that is initially closed and opens when a pressure within the package is greater than a predetermined valve opening pressure and stays open during heating in the microwave oven in order to completely exhaust the pressure formed in the package during heating.

### CROSS-REFERENCE TO RELATED APPLICATIONS

This application is a divisional application of U.S. patent application Ser. No. 10/228,430 filed Aug. 27, 2002, which claims priority of U.S. Provisional Patent Application Ser. No. 60/315,207 filed Aug. 27, 2001.

### FIELD OF THE INVENTION

A package for cooking food in a microwave and a method of use. More particularly, a package having a vent.

### BACKGROUND OF THE INVENTION

Various types of disposable containers have been developed for use in heating or cooking foods in microwave ovens. U.S. Pat. No. 4,961,944 to Matoba et al. discloses a flexible pouch for use in cooking frozen foods. The food is filled into the pouch which is sealed and then frozen. The pouch has a number of holes covered by an adhesive strip. The adhesive strip is removed before microwaving to provide a vent for steam which is generated during the microwave cooking process.

Plastic containers having lids with pressure relief valves are also known such as disclosed in PCT Application PCT/CH98/00546. This application discloses use of a container having a tray and rigid cover. The cover has a pressure relief valve which opens and closes to maintain a predetermined pressure range for pressure cooking fresh food in the container heated by a microwave. However, such packaging is relatively expensive and the shell life of fresh foods is relatively short.

Accordingly, it would be desirable to provide packaging which is inexpensive to produce, however can be used to eat the food after it has been heated. Additionally, it would be desirable to provide a method of providing prepared food in a microwave which provides a tasty meal and which has a long shelf life.

### SUMMARY OF THE INVENTION

Accordingly, a package for heating precooked food in a microwave and method of use has been devised. The package has a lower portion which is used for serving the food and ant upper portion having a vent. In one embodiment, the package is a flexible pouch having a bottom and a pair of sidewalls which are sealed at the top. The bottom is attached to the sidewalls with gussets so that the pouch stands up when rested on the bottom. A line of weakening extends from a notch in a side seam horizontally across the sidewalls to permit removal of the top portion after cooking by tearing the top and bottom portions apart. The top portion includes a vent for releasing steam generated by cooking from the package. The side walls of the bottom section have vertical reinforcement ribs formed to provide the sidewalls with sufficient rigidity to remain upright after the top is removed and form a serving dish for the food.

A first embodiment of the package is suitable for use with two food portions requiring different preparation. The package is similar to the pouch of the preferred embodiment, but after a first food portion is filled in the bottom, the pouch is sealed below and above the line of weakening. A second food portion is filled in to the upper portion. The upper and lower portions are separated before heating, thus one portion may be heated for a different period of time than the second portion or not heated at all.

A second embodiment includes a rigid tray having a cover formed of film. The cover includes a pressure relief device. The cover has a heat activated adhesive which may be peeled from the tray after the food portion is microwaved.

A method of preparing food utilizing the package includes precooking a food product until the food has a water content of approximately 20%, filling a package with a portion of said food product, sealing said package, freezing said food product, microwaving said package and food product for a predetermined length of time at a predetermined power, venting steam from the package during cooking with a pressure relief device mounted in an upper portion of the package, and removing the upper portion of said package and serving the lower portion of said package containing said portion of food product.

### BRIEF DESCRIPTION OF THE DRAWINGS

FIG. 1 is a front view of a package in accordance with an embodiment of the invention;

FIG. 2 is a cross-sectional view of a package in accordance with the invention,

FIG. 3 is a front view of the package partially separated along the line of weakening in accordance with the invention;

FIG. 4 is a perspective view of the package alter the top portion has been removed;

FIG. 5 is a front view of another embodiment of the flexible pouch;

FIG. 6 is a front view of the package after separation;

FIG. 7 is a perspective view of a package according to a further embodiment of the invention; and

FIG. 8 is a flow chart showing the method according to the invention.

### DETAILED DESCRIPTION OF THE PREFERRED EMBODIMENTS

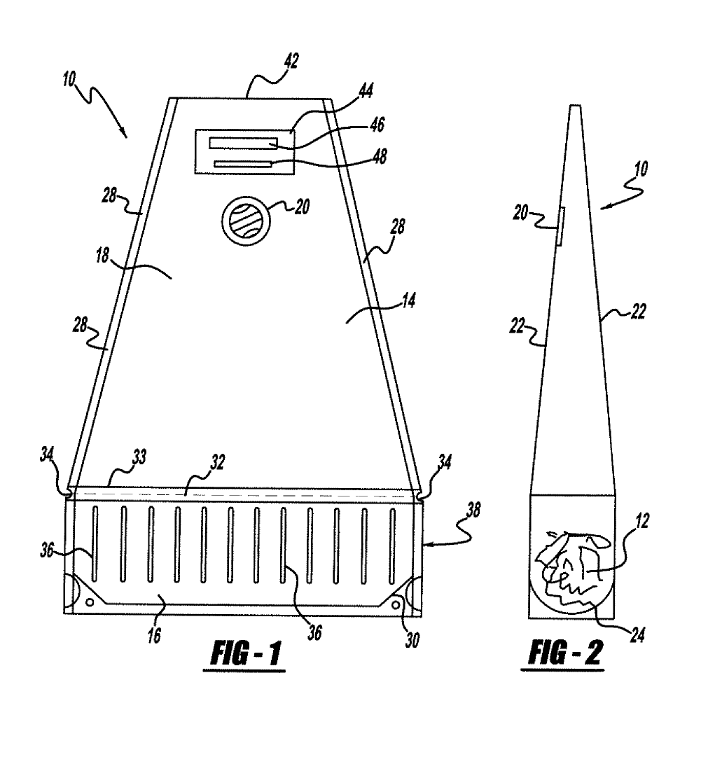

Shown in FIGS. 1-4 is a package 10 suitable for heating a precooked food portion 12 in a microwave oven. In this embodiment, the package 10 is a flexible stand-up pouch 14. The pouch 14 has a tray-like lower portion 16 containing the food portion 12 and an upper portion 18 having a vent 20.

As shown in FIGS. 1 and 2, the pouch 14 is formed of a pair of panels 22 and a bottom 24. As is known in the art, the panels 22 are welded together to form seams 28 and the bottom 24 is welded to the panels with gussets 30 so that the bottom of the pouch has a somewhat elliptical profile (FIG. 4) which permits the pouch 14 to stand up on the edges of the bottom of the panels 22. The pouch may be formed as known on a form-fill-seal machine. The pouch may be formed from a web of film of flexible material such as polyethylene, aluminum foil, VHOH, polypropylene. During the forming of the pouch, an embossed portion 33 is formed horizontally from seam 28 to seam 28 and a line of weakening 39 is formed with a laser through the embossed portion 33. A tear notch 34 is formed through each seam 28 to facilitate separation of the upper portion 18 from the lower portion 16 along the line of weakening 32 after the food portion has been heated. As shown in FIG. 4, the embossment provides smooth edges along the line of weakening after separation.

A plurality of spaced apart vertical ribs 36 are thermoformed onto the panels 22 of the lower portion 16 of the pouch 14. The ribs 36 provide rigidity to the panel 22 of the lower portion 16 so that the lower portion 16 forms a tray 38 with sides 40 formed from the portion of the panels 22 having the ribs 36 for serving the food portion 12 after the upper portion 18 is removed.

As shown in FIG. 1, the vent 20 is mounted on one panel 22 of the upper portion 18 of the pouch 14. The vent 20 exhausts steam from the package during cooking. The vent remains closed tightly until pressure from gas in the pouch reaches approximately 3 mbar during microwaving. The vent then remains open to vent gas from the package. Although many suitable vents such as holes covered by tape may be used, in the preferred embodiment the vent 20 is a pressure relief device having a Model Number W009, manufactured by WIPF of Volketswll, Switzerland. The pressure relief device also is operable to respire gas formed in the package prior to heating from decaying food or during freezing. The vent device 20 is welded in an aperture formed in the panel 22 during the forming process.

After the pouch is formed, the food portion 12 is filled through an opening formed between upper edges 42 of the panels 22. The upper edges 42 are sealed as known in the art by a satisfactory method such as heat sealing.

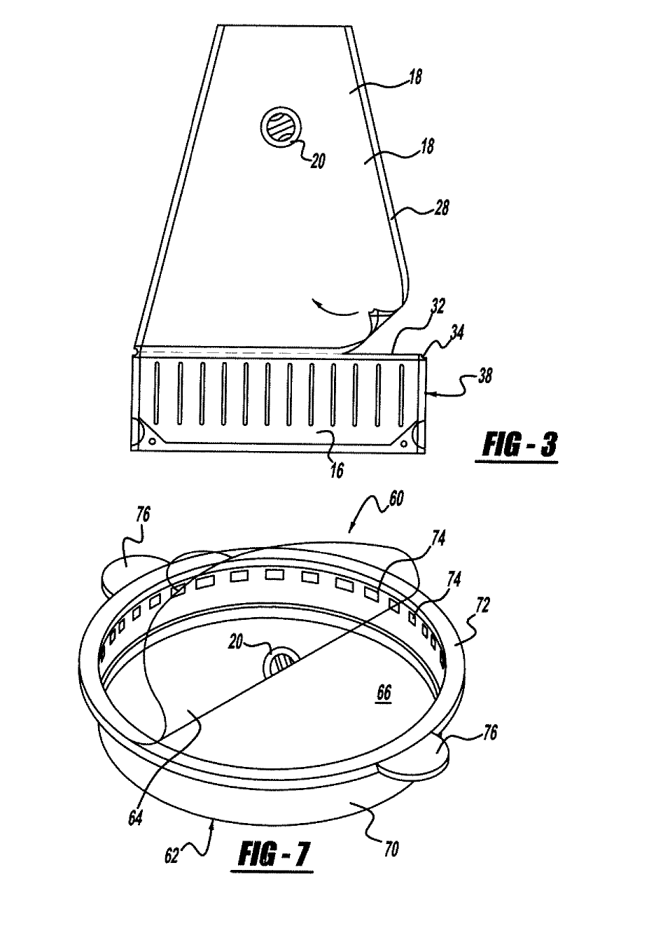

As shown in FIGS. 3 and 4, after the portion of food has been heated in the microwave, the upper portion 18 of the pouch is separated from the lower portion by ripping the pouch from the tear notch 34 on the seam 28 across the line of weakening 32, forming the tray 38 for serving the portion of food 12. The tray 38 sits on the bottom of the edges of the panels with the thermoformed ribs 36 supporting the sides 40.

As shown in FIG. 1, the package may be provided with a label 44 having bar coding 46 which is read by a scanner in the microwave, so that cooking time and temperature is automatically entered into the microwave. Additionally, a cooking temperature indicator 48 such as a strip of temperature-sensitive material which changes color upon reaching a certain temperature may be placed on the label so as to give an indication of when the food is properly heated.

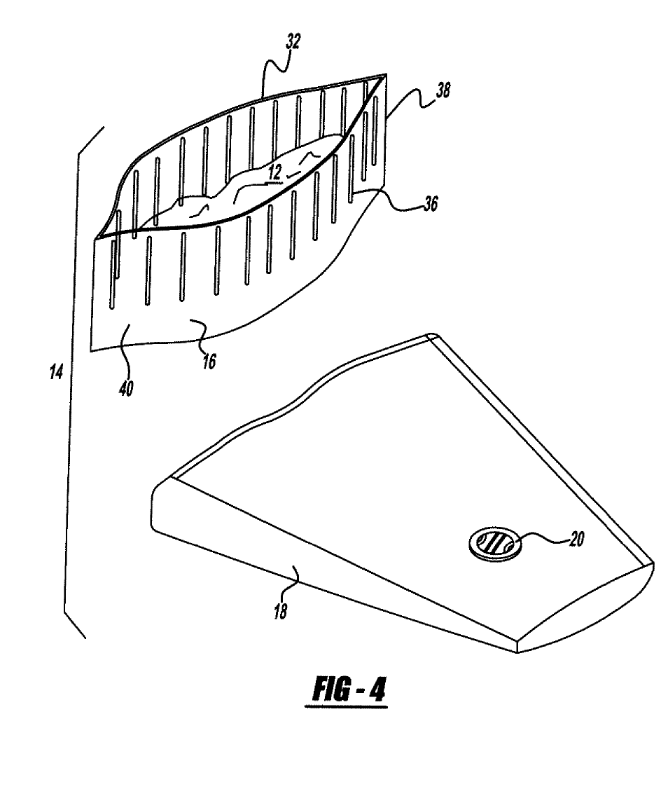

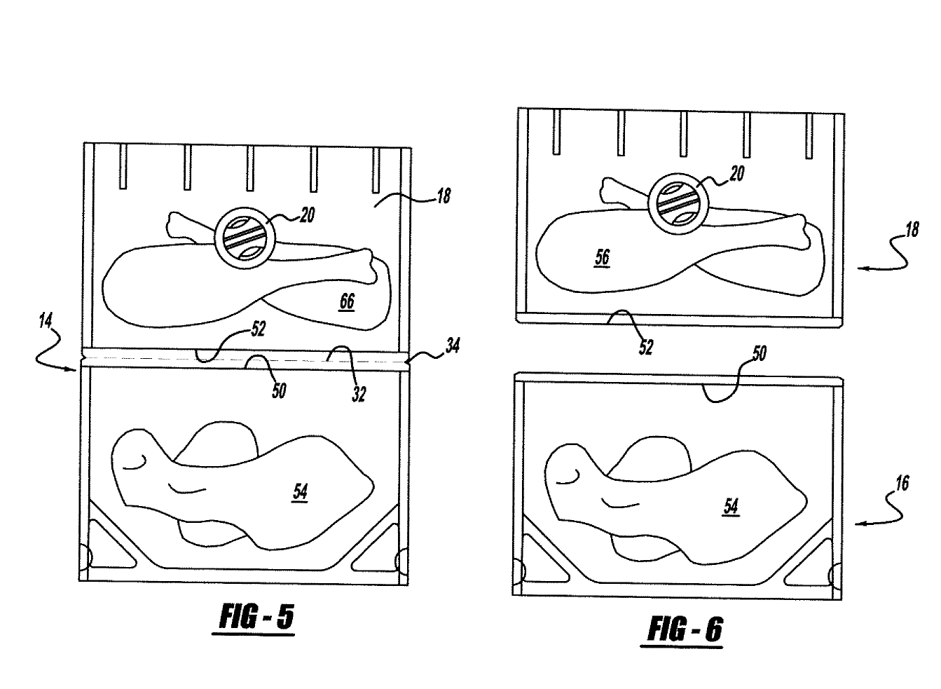

As shown in FIGS. 5 and 6, another embodiment of the pouch 14 is formed as discussed above. However, seals 50, 52 are formed on either side of the line of weakening 3 to permit the pouch to carry two different portions of food. After a first food portion 54, such as a salad, is filled into the lower portion 16 of the pouch, seals are formed on either side of the line of weakening. The seals 50, 52 are formed with a heat seal. Thus, a top of the lower portion is sealed by seal 50 and a bottom of the upper portion 18 is formed by seal 52. A second food portion 56, such as chicken, is then filled into the upper portion 18 and the upper edges 42 of the upper portion are then sealed as before.

When the meal is prepared, the upper portion 18 is separated from the lower portion 16 by way of the tear notches and line of weakening. As shown in FIG. 6, the upper portion 18 is placed in the microwave and heated. After heating, the seal 50 at the top of the lower portion is opened to form the tray 38 and access the salad 54. After the second food portion 56 is heated in the upper portion 18 of the pouch 14, the bottom seal 52 of the upper portion is opened and the second food portion 56 may be placed in the tray 38 for service as a meal. Alternatively, two different food products may be placed in the upper and lower portions 18, 16 and a second vent 20 is also mounted in the lower portion 16. In this way two food types which require different cooking times may be utilized. Both food portions may be served in the tray 38, as discussed above.

As shown in FIG. 7, a further embodiment is illustrated which includes a package 60 having a lower portion consisting of a tray 62 and a removable upper portion consisting of a heal sealable/peelable film cover 64. The film cover 64 includes a vent device 20. The tray is filled with a portion of food (not shown). The tray 62 is preferably produced of a clear plastic such as cast polypropylene. The tray 62 has a bottom 66 and a side 70 having a top edge 72. The tray should remain stable to −72° Celsius. The tray 62 has an oval shape and fibs 74 are formed in the side 70 to provide strength to the sides. A handle 76 is disposed at each end of the tray in order to facilitate moving of the tray 62 after the portions of food 12 have been heated.

The cover is formed of a film laminate having a polyester layer, a polypropylene layer, and an adhesive layer. The polyester layer has a thickness of 12.0 micrometers and a weight of 16.8 grams/m². The polypropylene layer has a thickness of 90.0 micrometers and a weight of 81.0 grams/m². The adhesive layer has a thickness of 2.5 micrometers and a weight of 2.5 grams/m². Such a film laminate has a low oxygen permeability and water vapor permeability. The sealing medium of the adhesive layer has a melting point of 165° Celsius and a sealing range of 180°-230° Celsius depending upon sealing time and pressure. Suitable adhesive layers are a mixture of a cast polypropylene and polyethylene. The film must be able to withstand a minimum of 120° Celsius heat. Film of this type is available from WIPF of Volketswll, Switzerland.

The film is supplied as a web. The web is unrolled and apertures are formed in the web at predetermined spaced apart locations. The vent device 20 is heat welded to the film and the apertures formed in the web. The portion of food 12 is filled into the tray 62 and the trays 62 are then delivered by a conveyor to a station where the web of film which is then sealed on the edge 72 of the tray and cut to the shape of the tray 62 and handles. After heating, the cover may be peeled from the tray and the food is served in the tray. Alternatively, the covers may be cut to the shape of the trays and supplied separately with the trays to small scale production facilities such as delis. At the deli, the food is filled in the tray as before, but the precut covers are placed on the tray and heat sealed on the tray in a machine which heats the adhesive to seal the cover to the tray.

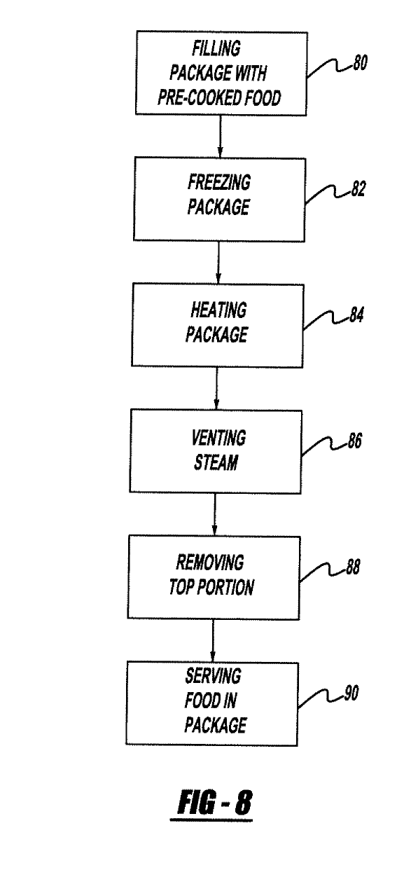

As shown in FIG. 8, the method of food preparation using the packaging includes first filling 80 a portion of precooked food having a moisture content which is generally 20% into a package. The food portion can be a single food item or can be a dish prepared to a recipe. The precooking prevents rapid decomposition of the food. Thus, food which has been at least partially precooked will have a shelf life of up to seventeen days whereas raw food will have a shelf life of approximately seven days. In the precooking or blanched state, the food is cooked until it reaches a temperature of 125° Celsius. Satisfactory temperature ranges for partially cooked food are set forth as follows:

| | Temperature |
|---|---|
| Food | Celsius |
| Chicken | 125 |
| Beef | 130 |
| Fish | 110 |
| Pork | 125 |
| Green beans | 105 |
| Carrots | 105 |
| Broccoli | 100 |

Examples of satisfactory recipes are set forth below.

### EXAMPLE 1

Seared Chicken and Rice with Vegetables

| | INGREDIENT | NOTES |
|---|---|---|
| AMOUNT | | |
| 135 g. | 90% cooked rice | Parboiled long grain rice |
| 40 g. | Blanched broccoli florets, | Blanched in salted water |
| | small | |
| 25 g. | ¼ inch sliced and seared | Seared in canola oil |
| | button mushrooms | |
| 25 g. | ¼ inch sliced, blanched | Blanched in salted water |
| | and half moon cut carrots | |
| 10 g. | Prepared chicken stock | Prepared from chicken base |
| | | paste and water |
| 120 g. | Seared and ¼ inch slight | Seasoned with kosher salt and |
| | bias-sliced chicken breast | fresh ground black pepper; |
| | | seared quickly on both sides. |
| | | Trimmed of all fat and |
| | | cartilage. |
| | | Seared in canola oil |
| 355 g. | | |
| METHOD | | |
| 1. | Place rice, vegetables and | |
| | chicken stock in base of | |
| | container | |
| 2. | Place chicken, slightly | |
| | shingled, in one line across | |
| | top of rice and vegetables | |
| 3. | Place top on container and | |
| | seal | |
| 4. | Microwave at 800 watts for | |
| | 4 minutes or until chicken is | |
| | just cooked through | |

### EXAMPLE 2

Penne Pasta Primavera with Seared Chicken

| | INGREDIENT | NOTES |
|---|---|---|
| AMOUNT | | |
| 125 g. | 90% cooked penne or farfalle | Cooked in salted water. Real |
| | pasta | Torino brand, 100% durum |
| | | semolina |
| 30 g. | Blanched broccoli florets, | Blanched in salted water |
| | small | |
| 25 g. | ¼ inch sliced and | Seared in canola oil |
| | seared button mushrooms | |
| 25 g. | ¼ inch sliced, blanched | Blanched in salted water |
| | and half moon cut carrots | |
| 20 g. | Frozen peas | |
| 60 g. | Prepared alfredo sauce | Digiorno brand |
| 10 g. | Prepared chicken stock | Prepared from chicken |
| | | base paste and water |
| 100 g. | Seared and ¼ inch | Seasoned with kosher salt and |
| | straight sliced chicken breast | fresh ground black pepper; |
| | | seared quickly on both sides. |
| | | Trimmed of all fat and |
| | | cartilage. |
| | | Seared in canola oil |
| 395 g. | | |
| METHOD | | |
| 1. | Combine pasta with | |
| | vegetables and alfredo sauce | |
| | and toss to coat well. Place | |
| | entire contents in base of | |
| | container | |
| 2. | Top with chicken slices in a | |
| | single layer | |
| 3. | Place top on container | |
| | and seal | |
| 4. | Microwave at 800 watts for 3 | |
| | minutes 30 seconds, or until | |
| | chicken is just cooked through | |

Once the food has been precooked, it is then cut in portions and then placed into a lower portion of the package. Total volume of the food must not exceed 500 grams for a container having a volume of 700 grams. The package has an upper portion having the vent device as discussed below. The oxygen may be purged from the package with a nitrogen bath. The package is sealed.

The next step is a freezing step 82 where the food in the package is then flash frozen and stored until meal time. The vent device may be of the type which respires during the freezing. If desired, the valve may be covered with a seal which is removed before cooking.

The next step is a heating step 84 where the package is then heated in a microwave at a predetermined power level and time as required for the recipe. While the food portion is being heated, steam is vented 86 from the package. The vent device 20 opens at a predetermined pressure, such as 3 mbar and remains fully open through the heating process.

The next step is to remove 88 the upper portion of the package. Finally, the heated food is served 90 in the lower portion 16 of the package 10.

It is understood that while certain embodiments of the present invention have been illustrated and described, the invention is not to be limited to specific forms or arrangements herein described and shown.

What is claimed is:

1. A flexible package for storing and heating a precooked food product in a microwave oven, the package comprising:
an upper portion;
a lower portion detachably connected to the upper portion, wherein the lower portion includes a side defining a cavity adapted to hold the food product during heating and to serve the food product after the upper portion is removed; and
a vent disposed in an aperture in the upper portion that operatively opens to release steam, wherein the vent is a valve that is initially closed and opens when a pressure within the package is greater than a predetermined valve opening pressure and stays open during heating in the microwave oven in order to completely exhaust the pressure formed in the package during heating.

2. The flexible package of claim 1, wherein the flexible pouch includes a seam separating the upper portion and the lower portion, and a line of weakening extending longitudinally therethrough the seam for detaching the upper portion from the lower portion.

3. The flexible package of claim 2, wherein the seam separating the upper portion and the lower portion includes a first seal on one side of the line of weakening and a second seal on an opposite side of the line of weakening, such that the upper portion forms an upper compartment for a first food product and the lower portion forms a lower compartment for a second food product.

4. The flexible package of claim 3 further comprising a second vent disposed in the lower portion.

5. The flexible package of claim 3 wherein the lower portion includes an opening means for providing access to the second food portion in the lower portion.

6. The flexible package of claim 1, wherein the lower portion includes integrally formed ribs that provide rigidity to the lower portion.

7. The flexible package of claim 1 wherein the lower portion is formed from a laminate material, and one layer of the laminate material is cast polypropylene.

8. The flexible package of claim 1, wherein the vent device respires to relieve gas from the decomposing food product in the package during storage.

9. The flexible of claim 1, wherein the vent device respires during freezing.

10. The flexible package of claim 1, further comprising a removable seal covering the vent during storage, and removable prior to heating of the package.

11. The flexible package of claim 1, wherein the food product is a freshly prepared food product having a moisture content of about 20%, and that is precooked up to a temperature of 125° C., and the flexible package has a refrigerated shelf life of up to seventeen days.

12. The flexible package of claim 11, wherein the fresh prepared food product occupies up to five-sevenths the volume of the package.

13. The flexible package of claim 1 wherein the predetermined opening pressure of the valve is 3 mbar.

14. A flexible package for storing and heating a precooked food product in a microwave oven, the package comprising:
an upper portion;
a lower portion detachably connected to the upper portion, wherein the lower portion includes a side defining a cavity adapted to hold the food product during heating and to serve the food product after the upper portion is removed;
a seam separating the upper portion and the lower portion, and a line of weakening extending longitudinally therethrough the seam for detaching the upper portion from the lower portion;
a vent disposed in an aperture in the upper portion that operatively opens to release steam, wherein the vent is a valve that is initially closed and opens when a pressure within the package is greater than a predetermined valve opening pressure of 3 mbar and stays open during heating in the microwave oven, in order to completely exhaust the pressure formed in the package during heating.

15. The flexible package of claim 14, wherein the seam separating the upper portion and the lower portion includes a first seal on one side of the line of weakening and a second seal on an opposite side of the line of weakening, such that the upper portion forms an upper compartment for a first food product and the lower portion forms a lower compartment for a second food product.

16. The flexible package of claim 15 further comprising a second vent disposed in the lower portion.

17. The flexible package of claim 14 wherein the lower portion includes an opening means for providing access to the second food product in the lower portion.

18. The flexible package of claim 14 wherein the food product is a freshly prepared food product having a moisture content of about 20%, and that is precooked up to a temperature of 125° C., and the flexible package has a refrigerated shelf life of up to seventeen days.

19. The flexible package of claim 15, wherein the fresh prepared food product occupies up to five-sevenths the volume of the package.

20. A flexible package for storing and heating a precooked food product in a microwave oven, the package comprising:
an upper portion;
a lower portion detachably connected to the upper portion, wherein the lower portion includes a side defining a cavity adapted to hold the food product during heating and to serve the food product after the upper portion is removed;
a seam separating the upper portion and the lower portion, and a line of weakening extending longitudinally therethrough the seam for detaching the upper portion from the lower portion, wherein the seam separating the upper portion and the lower portion includes a first seal on one side of the line of weakening and a second seal on an opposite side of the line of weakening, such that the upper portion forms an upper compartment for a first food product and the lower portion forms a lower compartment for a second food product; and
a vent disposed in an aperture in the upper portion that operatively opens to release steam, wherein the vent is a valve that is initially closed and opens when a pressure within the package is greater than a predetermined valve opening pressure of 3 mbar and stays open during heating in the microwave oven, in order to completely exhaust the pressure formed in the package during heating.

21. The flexible package of claim 20 further comprising a second vent disposed in the lower portion.

22. The flexible package of claim 20 wherein the lower portion includes an openings means for providing access to the second food product in the lower portion.

23. The flexible package of claim 20 wherein the food product is a freshly prepared food product having a moisture content of about 20%, and that is precooked up to a temperature of 125° C., and the flexible package has a refrigerated shelf life of up to seventeen days.
